(19) United States
(12) Patent Application Publication
(10) Pub. No.: US 2022/0306428 A1
(43) Pub. Date: Sep. 29, 2022

(54) LIFT SYSTEM

(71) Applicant: TK Elevator Innovation and Operations GmbH, Duesseldorf (DE)

(72) Inventor: Oliver Draeger, Reutlingen (US)

(73) Assignee: TK Elevator Innovation and Operations GmbH, Duesseldorf (DE)

(21) Appl. No.: 17/310,648

(22) PCT Filed: Feb. 11, 2020
(86) PCT No.: PCT/EP2020/053419

§ 371 Date: Mar. 18, 2022

(30) Foreign Application Priority Data
Feb. 18, 2019 (DE) 10 2019 202 111.5

(51) Int. Cl. B66B 9/00; B66B 7/02

(52) U.S. Cl. CPC B66B 9/003; B66B 7/021

(57) ABSTRACT

An elevator system includes a first lane oriented in a first direction, a second lane oriented in a second direction, a car configured to travel in the first and second lanes, a repositioning unit configured to reposition the car from the first lane to the second lane and from the second lane to the first lane, and a plurality of guide rails disposed in each of the first and second lanes that are configured to guide the car along each of the first lane and the second lane. The plurality of guide rails includes a plurality of rucksack guide rails configured to guide the car when it is at least one of already on the repositioning unit, entering the repositioning unit, or exiting the repositioning unit, and a plurality of lateral guide rails configured to guide the car when it is not in the repositioning unit.

### TECHNICAL FIELD

The invention relates to an elevator system.

### TECHNICAL BACKGROUND

DE 10 2014 220 966 A1 discloses an elevator system in which a plurality of cars is operated cyclically in circulating mode, similar to a paternoster. Unlike the traditional paternoster, each car is driven independently of the other cars and is therefore able to stop at any stopping point independently of the other cars. Repositioning units are provided to reposition the cars from a vertical lane into a horizontal lane, so that the cars can thereby be repositioned between different vertical lanes.

German patent application 10 2018 205 592.0 discloses a method for the assembly of rails in an elevator system of the aforementioned kind. In this way, the fact that the repositioning units and the fixed rails lying therebetween always have to be correctly aligned in respect of one another is taken into account. For this purpose, the rails have a length compensation, among other things.

EP 3 318 526 A1 discloses an elevator system in which a car can be moved between two vertical shafts within a transfer station. The car is guided in the shaft with the help of lateral guide rails. In this case, guide rails are always arranged on opposite sides of the car. With this kind of rail guidance, the center of gravity of the car is arranged substantially between the guide rails. In order to allow lateral movement of the car between the shafts, the car is moved between said shafts along with the portions of the lateral guide rail. The laterally movable portions of the lateral guide rails are received in the transfer station along with the car in a laterally displaceable cage (“elevator carriage guide 172” in EP 3 318 526 A1, para. [0035] and FIG. 3). However, if this cage is displaced between the shafts, the rail portions connected thereto are not available for the vertical travel of another car through the transfer station.

### DISCLOSURE OF THE INVENTION

The problem addressed by the present invention is that of providing an improved elevator system. This problem is solved by an elevator system and a method as claimed in the main claims; embodiments are the subject matter of the dependent claims and the description.

The elevator system according to the invention comprises:

at least a first lane which is oriented in a first direction, in particular vertically, at least a second lane which is oriented in a second direction deviating therefrom, in particular horizontally, and an optional third lane which is particularly oriented in the first direction, in particular parallel to the first lane. The elevator system further comprises at least one car, in particular a plurality of cars. Guide rails are set up to guide the car along the first and second lane and optionally the third lane, a repositioning unit to reposition the car from the first lane to the second lane and/or from the second lane to the first lane. The guide rails comprise rucksack guide rails which are set up to guide the car, at least while said car is in the repositioning unit, and/or at least while said car is entering the repositioning assembly, and/or at least while said car is moving out of the repositioning assembly. The guide rails further comprise lateral guide rails which are set up to guide the car when it is not in the repositioning unit, in particular while it is traveling in a vertical lane between two repositioning units.

The combined use of lateral guide rails and rucksack guide rails allows the specific advantages to be exploited. The rucksack guide rails allow a simple, safe, speedy repositioning of the car with little space being required by the repositioning unit. In addition, following a repositioning action the repositioning unit is immediately available for receiving or for the linear transit of another car, as the guide rails do not move away from the lane laterally with the car. On the other hand, during long and rapid vertical rides and braking maneuvers, the lateral guide rails are characterized by low roller wear and low vibration transmission via the rollers, since the weight force of the car is transmitted substantially centrally, in particular in the middle or virtually in the middle.

In one embodiment, a lateral guide rail gap is provided which, viewed in the direction of the first lane, is arranged between two lateral guide rails which are arranged adjacently, in particular vertically above one another. This allows the car to be transferred in a lateral direction through the gap. In the region of the repositioning assembly, the lateral guide rail does not therefore obstruct the sideways movement of the car. In one embodiment, the gap height of the lateral guide rail gap is greater than the height of the car for this purpose.

In one embodiment, an overlapping region is provided. A car located in the overlapping region is guided both by at least one rucksack guide rail and also by at least one lateral guide rail. In this way, a safe handover of the car between the lateral guide and the rucksack guide is created.

In one embodiment, while moving in the first lane and in the second lane and while in a repositioning unit, the car is constantly guided via the rucksack guide rails and/or the lateral guide rails. This means that in the aforementioned positions, one of the aforementioned guides always ensures minimum guidance, which improves the safety of the installation.

In one embodiment a repositioning assembly is provided for repositioning a car from a first lane, which is oriented in the first direction, to an adjacent third lane, which is likewise oriented in the first direction. A repositioning assembly of this kind comprises at least two repositioning units which are arranged in the second lane, and guide rails along the second lane which are arranged between the two repositioning units. During the transfer between the two repositioning units, the car is guided exclusively by rucksack guide rails.

The following method steps are provided in a method for repositioning a car from a first lane to a second and/or third lane in an aforementioned elevator system:
guidance of the car along lateral guide rails (21V) along the first lane,
transfer of the car from the lateral guide rails to rucksack guide rails,
transfer of the car to the second lane, wherein the car is guided by the rucksack guide rails. In one embodiment, the car is transferred into the third lane.

In one embodiment, the car is guided by rucksack guide rails when said car is transferred into the third lane.

In one embodiment, the car is transferred from the rucksack guide rails to the lateral guide rails and the car is guided along the lateral guide rails along the third lane.

In one embodiment, particularly during a vertical ride, the car travels through a repositioning unit. In this case, the car is initially guided along lateral guide rails along the first lane; the car is then transferred from the lateral guide rails to the rucksack guide rails; the car is then guided along the rucksack guide rails further along the first lane; the car is then transferred from the rucksack guide rails to the lateral guide rails; the car is then guided along the lateral guide rails further along the first lane.

Consequently, a transit of this kind involves a changeover of rail systems. With a transit of this kind, the car is not stopped, particularly between the guidance of the car along the lateral guide rails along the first lane and the intermediate transfer to the rucksack guide rails of the car. The car preferably continues to travel at a constant speed when passing through the repositioning unit.

### BRIEF DESCRIPTION OF THE DRAWING

The invention is explained in greater detail below with the help of the figures. They each show schematically

FIG. 1 details of an elevator system according to the invention as a perspective representation;

FIG. 2 the elevator system according to FIG. 1 as a schematic front view;

FIG. 3 a different position of the rail guide of the cars shown in FIG. 2 as a simplified plan view.

### DESCRIPTION OF EMBODIMENTS

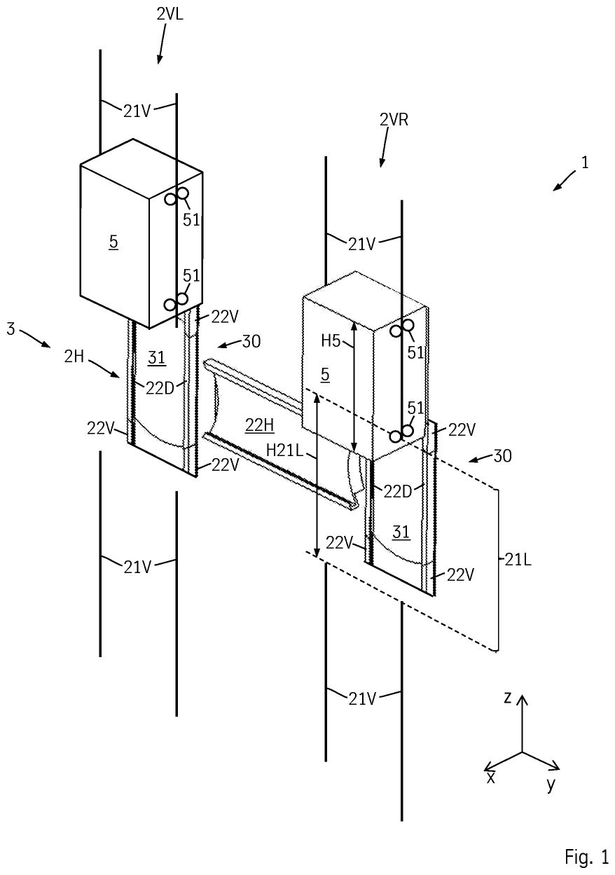

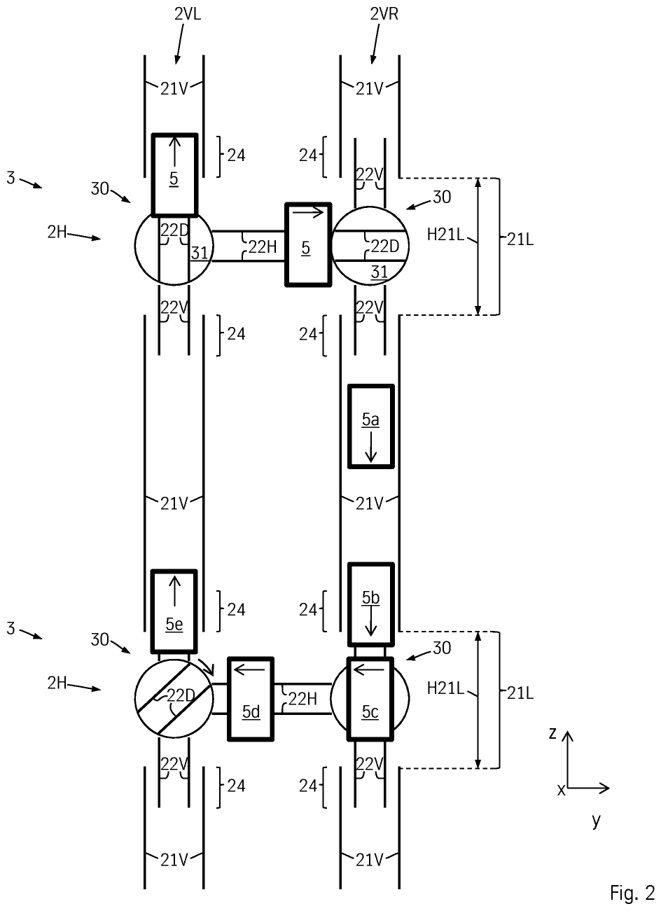

FIGS. 1 and 2 show parts of an elevator system 1 according to the invention. The elevator system 1 comprises a plurality of lanes 2H, 2V, along which a plurality of cars 5a-5h is guided.

A plurality of vertical lanes 2V, in this case two, for example, is oriented in a first direction along which the car 5 can be moved between different stories. Horizontal lanes 2H are arranged between the two vertical lanes 2V, along which the car 5 can be moved within a story in each case. In addition, the horizontal lane 2H connects the two vertical lanes 2V to one another. Consequently, the horizontal lane 2H is also used to transfer the car 5 between the two vertical lanes 2V, in order to realize a modern paternoster operation, for example. Further horizontal lanes 2H of this kind, which connect the two vertical guide rails to one another, are provided in the elevator system 1. In addition, further vertical lanes 2V which are not depicted may be provided.

Guide rails 21V, 22V, 22H, 22D for guiding the cars are provided along the lanes 2V, 2H. The cars have guide rollers 51 for this purpose, which are depicted in FIG. 1 for guidance on the rail 21V, for example.

The guide rails comprise rucksack guide rails 22V, 22H, 22D. Rucksack guide rails are arranged on a common side of the car. The car 5, in particular the center of gravity of the car 5, is arranged in a constantly projecting manner in this case. The weight force is transmitted to the rucksack guide rails through the introduction of bending moments.

The rucksack guide rails comprise fixed vertical rucksack guide rails 22V which are oriented along the vertical lane. The rucksack guide rails comprise fixed horizontal rucksack guide rails 22H which are oriented along the horizontal lane 2H.

The car can be repositioned from one of the vertical lanes 2V to the other of the vertical lanes 2V via a repositioning assembly 3.

The repositioning assembly 3 comprises two repositioning units 30 and a horizontal rucksack guide rail 22H. The car 5 can be transferred between one of the vertical rucksack guide rail 22V and the horizontal rucksack guide rail 22H in each case via the repositioning units 30. The repositioning unit 30 in this case comprises a rotatable rucksack guide rail 22D.

All guide rails are installed at least indirectly in a shaft wall 20. Up to this point, the elevator system basically corresponds to the description given in WO 2015/144781 A1 and also in DE10 2016 211 997A1 and DE 10 2015 218 025 A1.

The guide rails further comprise vertical lateral guide rails 21V. Two vertical lateral guide rails 21V in each case are attached to opposite sides of the car 5. The center of gravity of the car 5 is substantially arranged between the vertical guide rails (viewed in the y-direction). It is self-evident that particularly due to the design and/or load, the center of gravity of the car 5 at least in twos is not exactly arranged between the vertical lateral guide rails 21V (centered with the vertical lateral guide rails in x direction). Vertical lateral guide rails 21V of this kind have a variety of isolated uses in traditional elevator systems.

The special feature of the invention lies in an alternating arrangement of vertical lateral guide rails 21V and vertical rucksack guide rails 22V along the vertical lane 2V. Hence, the vertical rucksack guide rails 22V are arranged in the region of the repositioning units 30; the vertical lateral guide rails 21V span the region between two repositioning units 30.

The vertical lateral guide rails 21V are interrupted in the region of the repositioning units 30. To this extent, the repositioning units 30 are each arranged in a lateral guide rail gap 21L. Consequently, the vertical lateral guide rails 21V do not obstruct the lateral transfer of the car 5.

A gap height H21L of the lateral guide rail gap 21L is greater than the height H5 of the car. Consequently, the car fits through the lateral guide rail gap 21L during the lateral transfer action.

In the region of the repositioning assembly 3, the use of the rucksack guide rails facilitates a rapid repositioning of the car 5 between the vertical lanes 2V. It is essential in this case for a kind of swinging cage to be used which receives the car during the repositioning between lanes, as explained in the introduction to EP 3 318 526 A1.

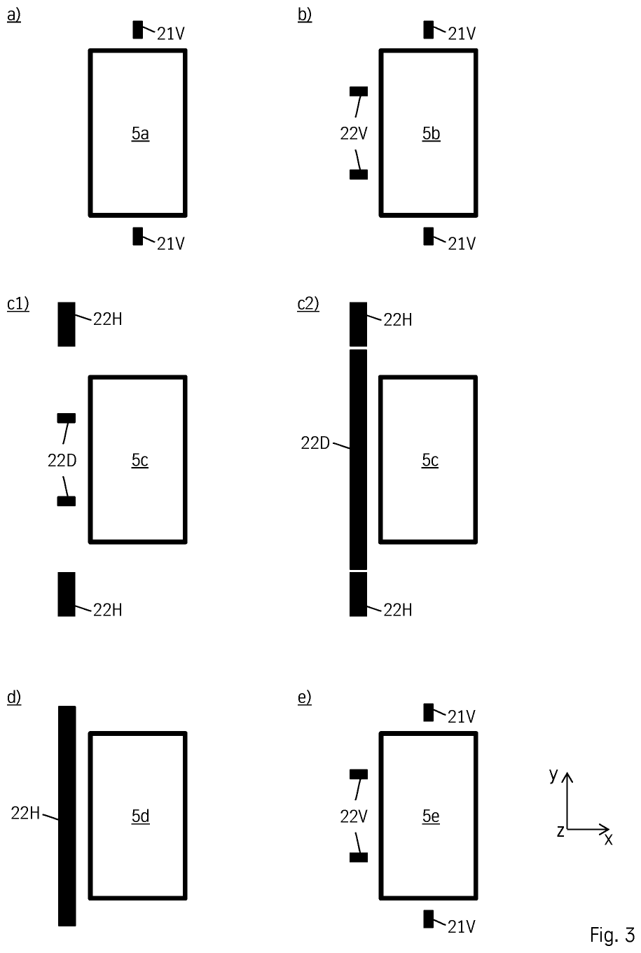

The different positions in the rail guidance of a car are described below with the help of FIGS. 3a-e. The cars 5a-5e depicted there correspond to the cars 5a-e in the respective positions thereof shown in FIG. 2. For simplification purposes, only the cars 5 and those rails on which the car is guided in this position are schematically depicted in FIGS. 3a-3e. The associated rollers are not shown for reasons of clarity.

The car 5a is located in the position shown in FIG. 3a in a region between two repositioning units 30. The car 5a is only guided by the vertical lateral guide rails.

In the position depicted in FIG. 3b the car 5b is located in an overlapping region 24 in which the vertical lateral guide rails 21V and the vertical rucksack guide rails 22V are arranged in overlapping fashion in the direction of travel. The car 5b is guided both by the vertical lateral guide rails 21V and also by the vertical rucksack guide rails 22V, facilitating a safe and comfortable transition from the lateral guide rails 21V to the rucksack guide rails 22V.

In the positions shown in FIGS. 3c1 and 3c2 the car 5c is located in one of the repositioning units 30 and therefore also in the region of a lateral guide rail gap 31L. The car 5c is guided exclusively by the rotatable rucksack guide rails 22D.

In the position shown in FIG. 3c1, the rotatable rucksack guide rails 22D are oriented vertically and therefore aligned with the fixed vertical rucksack guide rails 22V (not shown). The car 5 can be transferred between the vertical rucksack guide rails 22V and the rotatable rucksack guide rails 22D.

In the position shown in FIG. 3c2, the rotatable rucksack guide rails 22D are oriented horizontally and therefore aligned with the horizontal rucksack guide rails 22H. The car 5 can be transferred between the horizontal rucksack guide rails 22H and the rotatable rucksack guide rails 22D.

In the position shown in FIG. 3d the car 5d is located in a horizontal lane between two repositioning units 30. The car 5d is guided exclusively by the horizontal rucksack guide rails 22H.

In the position shown in FIG. 3e the car 5e is likewise located in an overlapping region 24. The car 5b is guided both by the vertical lateral guide rails 21V and by the vertical rucksack guide rails 22V, facilitating a safe and comfortable transition from the vertical rucksack guide rails 22V to the vertical lateral guide rails 21V.

As soon as the car has left the rotatable rucksack guide rail along the horizontal rail 22H during repositioning, the rotatable rail 22D can be turned back again into the vertical orientation. The next car can then move straight into the repositioning unit, e.g. in order to perform the next repositioning action or for a vertical transit.

As soon as the car has left the rotatable rucksack guide rail along the vertical rails 22V, 21V following the repositioning, the rotatable rail 22D can be turned back again into the horizontal orientation. The next car can then move straight into the repositioning unit, e.g. in order to perform the next repositioning action or for a horizontal transit.

The overlapping region 24 also allows a substantial increase in tolerances during assembly of the vertical rails. The vertical rails are not in a line over the entire length of the lane (=shaft height). Heat-induced length changes in the vertical rails or a settlement of the building still have virtually no impact, provided the overlapping region 24 is of an adequate size.

### LIST OF REFERENCE SIGNS

1 elevator system
2H horizontal lane
2VL, 2VR vertical lane
21V lateral guide rail, vertical
21L lateral guide rail gap
22V fixed rucksack guide rail, vertical
22H fixed rucksack guide rail, horizontal
22D rotatable rucksack guide rails
24 overlapping region
3 repositioning assembly
30 repositioning unit
31 pivot mounting
5 car
51 guide rollers
H21L height of the lateral guide rail gap
H5 height of the car

1.-13. (canceled)

14. An elevator system, comprising:
a first lane oriented in a first direction;
a second lane oriented in a second direction;
a car configured to travel in said first and second lanes;
a repositioning unit configured to reposition said car from said first lane to said second lane and from said second lane to said first lane; and
a plurality of guide rails disposed in each of said first and second lanes that are configured to guide said car along each of said first lane and said second lane, said plurality of guide rails including,
a plurality of rucksack guide rails configured to guide said car when said car is at least one of already on said repositioning unit, entering said repositioning unit, or exiting said repositioning unit, and
a plurality of lateral guide rails configured to guide said car when it is not in the repositioning unit.

15. The elevator system of claim 14, further comprising:
a lateral guide rail gap defined, in a direction of said first lane, between two lateral guide rails adjacently disposed vertically above one another.

16. The elevator system of claim 15, wherein a gap height of the lateral guide rail gap is greater than a height of the car.

17. The elevator system of claim 14, further comprising:
an overlapping region which, when said car is located within said overlapping region, said car is guided by both of at least one of said rucksack guide rails and by at least one of said lateral guide rails.

18. The elevator system of claim 14, wherein said first lane and said second lane are configured such that, while said car is moving in either of said first or second lane and positioned within said repositioning unit, said car is constantly guided by at least one of said rucksack guide rails or said lateral guide rails.

19. The elevator system of claim 14, further comprising:
a repositioning assembly including,
at least two repositioning units disposed in said second lane, and
a plurality of guide rails disposed along said second lane between said two repositioning units,
said repositioning assembly being configured to,
reposition said car from said first lane oriented in the first direction, to an adjacent third lane also oriented in the first direction, and
guide said car solely by said rucksack guide rails during a transfer of said car between said two repositioning units.

20. A method for repositioning a car from a first lane to a second and/or third lane in an elevator system of claim 14, the method comprising:
guiding the car on lateral guide rails along the first lane;
transferring the car from the lateral guide rails to rucksack guide rails;
transferring the car to the second lane; and
guiding the car in the second lane on rucksack guide rails.

21. The method of claim 20, further comprising:
transferring the car to a third lane.

22. The method of claim 21, wherein said transferring of the car to the third lane is performed by guiding the car on rucksack guide rails into the third lane.

23. The method of claim 22, further comprising:
transferring the car from the rucksack guide rails in the third lane, to lateral guide rails in the third lane; and
guiding the car on the lateral guide rails along the third lane.

24. A method for moving a car of the elevator system of claim 14across a repositioning unit disposed in a first lane, the method comprising:
guiding the car on a first set of lateral guide rails in the first lane;
transferring the car from the first set of lateral guide rails in the first lane to rucksack guide rails in the first lane;
guiding the car along the rucksack guide rails and across a repositioning unit in the first lane;
transferring the car from the rucksack guide rails in the first lane to a second set of lateral guide rails in the first lane; and
guiding the car along the second set of lateral guide rails in the first lane.

25. The method of claim 24, wherein the car is not stopped between the step of guiding the car on a first set of lateral guide rails in the first lane and the intermediate step of transferring the car from the first set of lateral guide rails in the first lane to rucksack guide rails in the first lane.

26. The method of claim 25, wherein the car travels at a constant speed between the step of guiding the car on a first set of lateral guide rails in the first lane and the intermediate step of transferring the car from the first set of lateral guide rails in the first lane to rucksack guide rails in the first lane.
